(19) United States
(12) Patent Application Publication
(10) Pub. No.: US 2018/0184617 A1
(43) Pub. Date: Jul. 5, 2018

(54) Pest deterrent system

(71) Applicants: Charles W. Kohler, Pattison, TX (US); Sandra D. Larson, Pattison, TX (US)

(72) Inventors: Charles W. Kohler, Pattison, TX (US); Sandra D. Larson, Pattison, TX (US)

(21) Appl. No.: 15/732,716

(22) Filed: Dec. 19, 2017

Related U.S. Application Data
(60) Provisional application No. 62/498,639, filed on Dec. 30, 2016.
(60) Provisional application No. 62/602,294, filed on Apr. 19, 2017.

(51) Int. Cl. A01K 5/02; A01M 29/24; A01M 31/00

(52) U.S. Cl. CPC A01K 5/0225; A01M 31/008; A01M 29/24

(57) ABSTRACT

A wild game feeder of the type having a feed hopper supported off the ground by one or more legs. If the feeder is a gravity feeder having one or more feed ports, then oppositely charged electrode grids are placed side by side on the feed ports in relation to the longitudinal axis of the feed ports. Oppositely charged electrode grids can also be placed side by side in relation to the longitudinal axis of the legs of the feeder on supports placed on the legs of the feeder

### BACKGROUND OF THE INVENTION

The instant invention relates to pest deterrent devices. In general, many devices have been used to prevent raccoons, wild pigs, bears and other pest animals from feeding from or even destroying a feeding station devoted to feeding game animals such as deer. Devices and systems incorporating electrical shock are known such as the system of U.S. Pat. No. 6,125,595 and US Patent Application Publication 2014/0318473. However, there remains a need for a pest deterrent system better suited for preventing raccoons, wild pigs, bears and other pest animals from feeding from or even destroying a feeding station devoted to feeding game animals such as deer.

### SUMMARY OF THE INVENTION

The instant invention is an important discovery in the field of deterring raccoons, wild pigs, bears and other pest animals from feeding from or destroying a feeding station devoted to feeding game animals such as deer. In one embodiment, the instant invention is a feeding station for feeding game animals such as deer or elk, comprising: (a) a feed hopper; (b) one or more legs to support the feed hopper off the ground, each leg having a longitudinal axis; (c) an electrode support attached to each leg, the electrode support comprising an electrically non-conductive material; (d) a first electrode attached to each electrode support; (e) a second electrode attached to each electrode support, the first and second electrodes positioned apart from each other and side by side from each other relative to the longitudinal axis of each leg; and (f) a source of electricity in electrical communication with each first and second electrodes to maintain an electrical potential between each first and second electrode, the first and second electrodes comprised of a grid of electrically conductive material. The grid of electrically conductive material preferably comprises wire fencing material. The source of electricity is preferably a solar powered electric fence charger.

In another embodiment the instant invention is a feeding station for feeding game animals such as deer or elk, comprising: (a) a feed hopper; (b) one or more legs to support the feed hopper off the ground, each leg having a longitudinal axis; (c) one or more feed ports in gravity communication with the feed hopper so that granulated feed contained in the feed hopper can flow by gravity from the feed hopper into the one or more feed ports from which said feed can be eaten by an animal, each one or more feed ports having a longitudinal axis; (d) an electrode support attached to each said feed ports, the electrode support comprising an electrically non-conductive material; (e) a first electrode attached to the electrode support; (f) a second electrode attached to each electrode support, the first and second electrodes positioned apart from each other and side by side from each other relative to the longitudinal axis of each feed port; and (g) a source of electricity in electrical communication with each first and second electrodes to maintain an electrical potential between each first and second electrode, the first and second electrodes comprised of a grid of electrically conductive material. The grid of electrically conductive material preferably comprises wire fencing material. The source of electricity is preferably a solar powered electric fence charger. The electrode support of each feed port and each feed port can be an integral unit.

In yet another embodiment, the instant invention is a feeding station for feeding game animals such as deer or elk, comprising: (a) a feed hopper; (b) one or more legs to support the feed hopper off the ground, each leg having a longitudinal axis; (c) an electrode support attached to each leg, the electrode support comprising an electrically non-conductive material; (d) a first electrode attached to each electrode support; (e) a second electrode attached to each electrode support, the first and second electrodes positioned apart from each other and side by side from each other relative to the longitudinal axis of each leg; (f) one or more feed ports in gravity communication with the feed hopper so that granulated feed contained in the feed hopper can flow by gravity from the feed hopper into the one or more feed ports from which said feed can be eaten by an animal, each one or more feed ports having a longitudinal axis; (g) a feed port electrode support attached to each said feed ports, the feed port electrode support comprising an electrically non-conductive material; (h) a third electrode attached to each feed port electrode support; (i) a fourth electrode attached to each feed port electrode support, the third and fourth electrodes positioned apart from each other and side by side from each other relative to the longitudinal axis of each feed port; and (j) the source of electricity in electrical communication with each first, second, third and fourth electrodes to maintain an electrical potential between each first and second electrodes and between each third and fourth electrodes, the first, second, third and fourth electrodes comprised of a grid of electrically conductive material. The grid of electrically conductive material preferably comprises wire fencing material. The source of electricity is preferably a solar powered electric fence charger. The electrode support of each feed port and each feed port can be an integral unit.

### BRIEF DESCRIPTION OF THE DRAWINGS

FIG. 1 is a perspective view of a prior art gravity feeder primarily intended for feeding deer or elk;

FIG. 2 is a perspective view of the gravity feeder shown in FIG. 1 configured according to a highly preferred embodiment of the instant invention;

FIG. 3 is a perspective view showing details of the feed ports shown in FIG. 2;

FIG. 4 is a perspective view showing details of the leg electrode system shown in FIG. 2; and

FIG. 5 is a drawing showing details of the solar powered electrode charging system shown in FIG. 2.

### DETAILED DESCRIPTION OF THE INVENTION

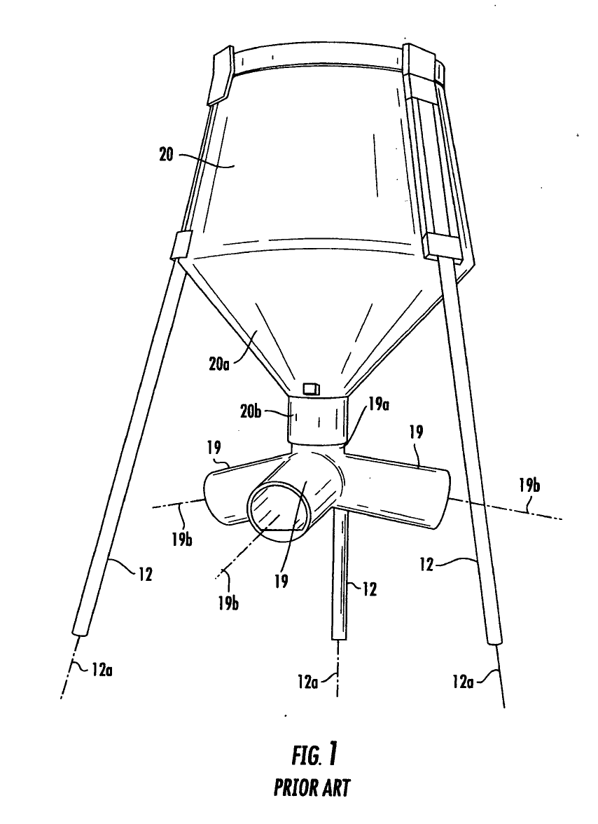

Referring now to FIG. 1, therein is shown a perspective view of a prior art BOSS BUCK brand gravity feeder, which feeder is primarily intended for feeding deer or elk. The feeder is comprised of a feed hopper 20 supported off the ground by legs 12, each leg 12 having a longitudinal axis 12a. The feeder comprises feed ports 19 in gravity communication with feed hopper 20 so that granulated feed contained in the feed hopper 20 can flow by gravity from the funnel portion 20a of feed hopper 20 through collar 20b, through feed port inlet 19a into the feed ports 19 from which said feed can be eaten by an animal, each feed port having a longitudinal axis 19b. When placed to feed deer or elk, pests such as raccoons can climb legs 12 and eat feed from feed ports 19. When placed to feed deer or elk, wild hogs can bump legs 12 to jar feed from feed ports 19 and can even tip over and destroy a feeder. When placed to feed deer or elk, bear will stand on their hind legs grasp a feed port 19 with their front paws and eat feed from the feed port 19 and even destroy the feeder.

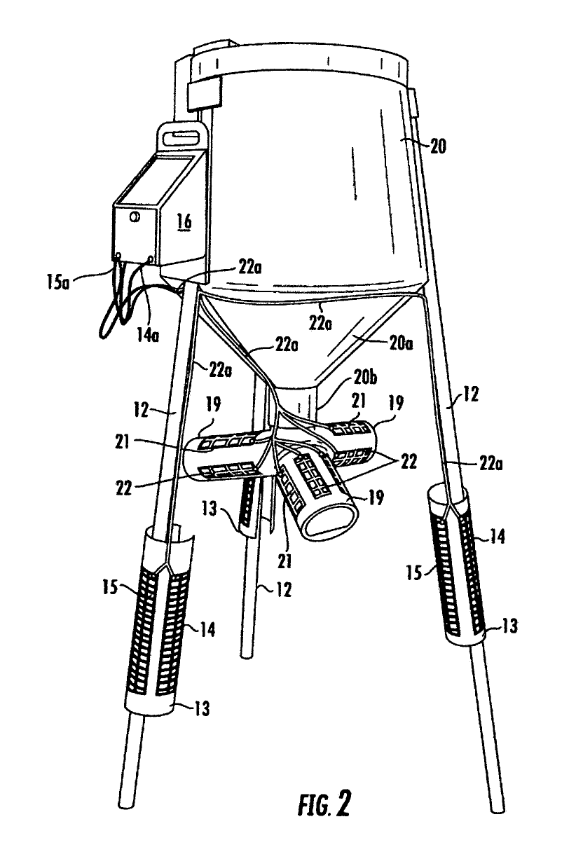

Referring now to FIG. 2, therein is shown a perspective view of the gravity feeder shown in FIG. 1 configured according to a highly preferred embodiment of the instant invention. In this embodiment, the feed ports 19 are made of a non-conductive plastic. Steel wire fencing electrodes 21 and 22 are positioned side by side in relation to the longitudinal axis of the feed ports 19. Electrodes 21 and 22 are connected to solar powered electric fence charger 16 by way of electric cable 22a. A bear grasping a feed port 19 in an attempt to eat feed from feed port 19 is shocked by the electric potential difference between electrodes 21 and 22. The grid structure of electrodes 21 and 22 is important because a bears claws engage with such grid structure. The side by side relationship of electrodes 21 and 22 relative to the longitudinal axis of feed port 19 is important because such a relationship increases the probability of shocking a bear attempting to feed at feed port 19. Steel wire fencing electrodes 14 and 15 are positioned on electrically non-conductive sections of PVC slotted pipe 13. Electrodes 14 and 15 are positioned side by side in relation to the longitudinal axis of legs 12. Electrodes 14 and 15 are also connected to solar powered electric fence charger 16 by way of electric cable 22a. A raccoon climbing one of legs 12 is shocked when contacting electrodes 14 and 15. The grid structure of electrodes 14 and 15 is important because a raccoons claws engage with such grid structure. A wild pig bumping on one of legs 12 tends to contact electrodes 14 and 15 because of their side by side relationship relative to the longitudinal axis of leg 12.

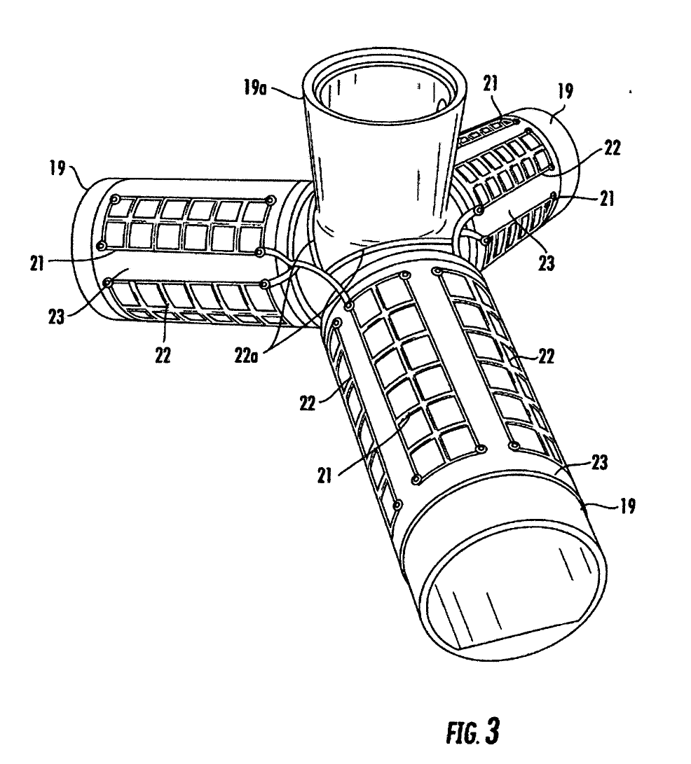

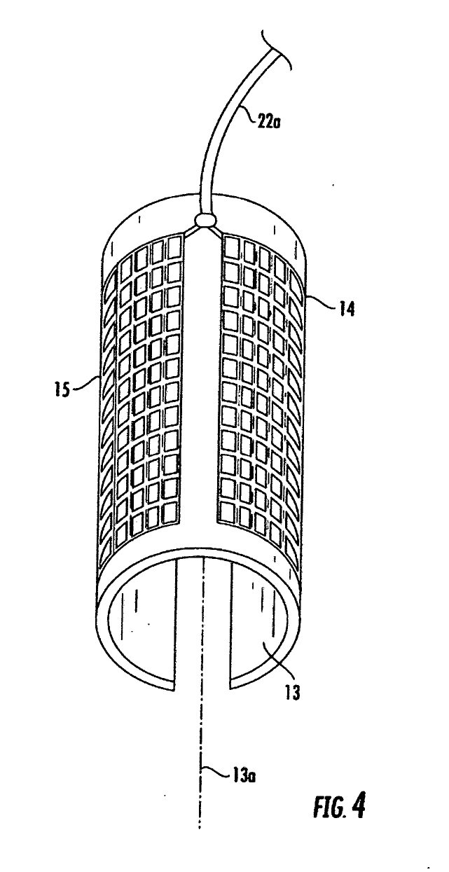

Referring now to FIG. 3, therein is shown a perspective view showing details of the feed ports shown in FIG. 2 wherein electrodes 21 and 22 are placed on non-conductive support 23. Non-conductive support 23 can be used when feed ports 19 are made of an electrically conductive metal. Electrodes 21 and 22 can be placed directly on feed ports 19 when feed ports 19 are made of electrically non-conductive plastic. Referring now to FIG. 4, therein is shown a detailed view of electrode support 13 having longitudinal axis 13a, electrodes 14 and 15 and cable 22a.

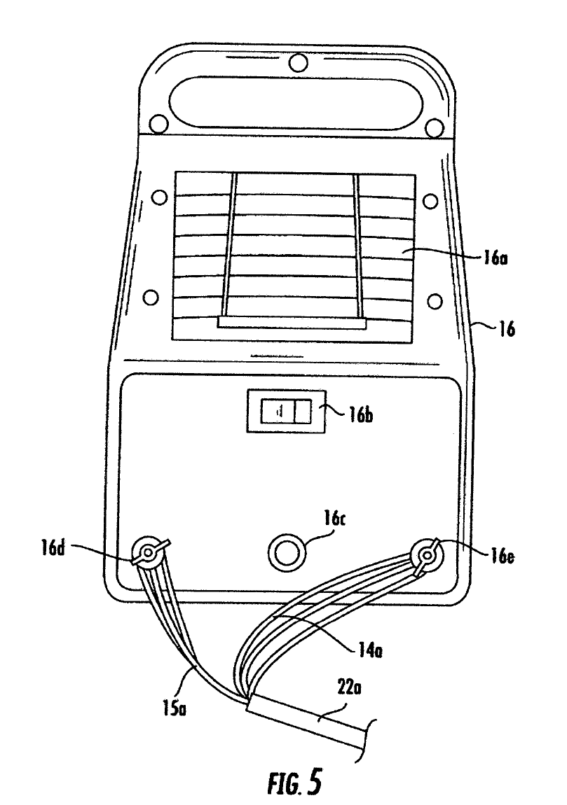

Referring now to FIG. 5, therein is shown a perspective view showing details of AMERICAN FARM WORKS brand 2-MILE SOLAR FENCE CHARGER 16 available from Tractor Supply Co. Charger 16 comprises solar panel 16a, on-off switch 16b, on indication light 16c, positive terminal 16d and negative terminal 16e. Wire 14a is connected to electrodes 14 and 21. Wire 15a is connected to electrodes 15 and 22. Wires 14a are 15a are sheathed in cable 22a.

The components of the instant invention can be made of any suitable material. As mentioned above, PVC pipe is the preferred material for the electrode support 13 but any material can be used as long as it is not electrically conductive. The electrodes are preferably the above-mentioned steel wire fencing but can comprise any grid material that is electrically conductive such as a grid of copper or stainless steel. The term “grid” is intended to include, without limitation thereto, a woven wire fencing material as well as a perforated structure such as expanded sheet metal. The source of electricity is preferably a solar powered electric fence unit but can be any suitable source of electricity capable of shocking an animal. It should be understood that the instant invention can be used with any game feeder including gravity and spin cast game feeders. With regard to spin cast game feeders, the instant invention helps prevent damage to, for example and without limitation thereto, the solar panel, control box, batteries and wiring of a spin cast feeder. An important advantage of the instant invention is that it does not require an earth ground and so can be used in rocky and dry locations. The embodiment detailed in FIG. 4 is highly preferred for convenient application to the legs of a feeder.

### CONCLUSION

While the instant invention has been described above according to its preferred embodiments, it can be modified within the spirit and scope of this disclosure. This application is therefore intended to cover any variations, uses, or adaptations of the instant invention using the general principles disclosed herein. Further, the instant application is intended to cover such departures from the present disclosure as come within the known or customary practice in the art to which this invention pertains.

What is claimed is:

1. A feeding station for feeding game animals such as deer or elk, comprising: (a) a feed hopper; (b) one or more legs to support the feed hopper off the ground, each leg having a longitudinal axis; (c) an electrode support attached to each leg, the electrode support comprising an electrically non-conductive material; (d) a first electrode attached to each electrode support; (e) a second electrode attached to each electrode support, the first and second electrodes positioned apart from each other and side by side from each other relative to the longitudinal axis of each leg; and (f) a source of electricity in electrical communication with each first and second electrodes to maintain an electrical potential between each first and second electrode, the first and second electrodes comprised of a grid of electrically conductive material.

2. The feeding station of claim 1, wherein the grid of electrically conductive material is comprised of wire fencing.

3. The feeding station of claim 2, wherein the source of electricity is a solar powered electric fence charger.

4. A feeding station for feeding game animals such as deer or elk, comprising: (a) a feed hopper; (b) one or more legs to support the feed hopper off the ground, each leg having a longitudinal axis; (c) one or more feed ports in gravity communication with the feed hopper so that granulated feed contained in the feed hopper can flow by gravity from the feed hopper into the one or more feed ports from which said feed can be eaten by an animal, each one or more feed ports having a longitudinal axis (d) an electrode support attached to each said feed ports, the electrode support comprising an electrically non-conductive material; (e) a first electrode attached to the electrode support; (f) a second electrode attached to each electrode support, the first and second electrodes positioned apart from each other and side by side from each other relative to the longitudinal axis of each feed port; and (g) a source of electricity in electrical communication with each first and second electrodes to maintain an electrical potential between each first and second electrode, the first and second electrodes comprised of a grid of electrically conductive material.

5. The feeding station of claim 4, wherein the grid of electrically conductive material is comprised of wire fencing.

6. The feeding station of claim 5, wherein the source of electricity is a solar powered electric fence charger.

7. The feeding station of claim 6, wherein the electrode support and each feed port are an integral unit.

8. The feeding station of claim 1, further comprising: (g) one or more feed ports in gravity communication with the feed hopper so that granulated feed contained in the feed hopper can flow by gravity from the feed hopper into the one or more feed ports from which said feed can be eaten by an animal, each one or more feed ports having a longitudinal axis (h) a feed port electrode support attached to each said feed ports, the feed port electrode support comprising an electrically non-conductive material; (i) a third electrode attached to each feed port electrode support; (j) a fourth electrode attached to each feed port electrode support, the third and fourth electrodes positioned apart from each other and side by side from each other relative to the longitudinal axis of each feed port; and (k) the source of electricity in electrical communication with each third and fourth electrodes to maintain an electrical potential between each third and fourth electrode, the third and fourth electrodes comprised of a grid of electrically conductive material.

9. The feeding station of claim 7, wherein each grid of electrically conductive material is comprised of wire fencing.

10. The feeding station of claim 8, wherein the source of electricity is a solar powered electric fence charger.

11. The feeding station of claim 10, wherein the electrode support of each feed port and each feed port are an integral unit.
